(19) United States
(12) Patent Application Publication
(10) Pub. No.: US 2014/0012918 A1
(43) Pub. Date: Jan. 9, 2014

(54) METHOD AND APPARATUS FOR CREATING AN EPHEMERAL SOCIAL NETWORK

(71) Applicants: Alvin Chin, Chaoyang (CN); Hao Wang, Beijing (CN); Hao Wang, Beijing (CN)

(72) Inventors: Alvin Chin, Chaoyang (CN); Hao Wang, Beijing (CN); Hao Wang, Beijing (CN)

(73) Assignee: Nokia Corporation, Espoo (FI)

(21) Appl. No.: 14/005,947

(22) PCT Filed: Mar. 29, 2011
(86) PCT No.: PCT/CN11/72234

§ 371 Date: Sep. 18, 2013

(51) Int. Cl. H04L 29/08

(52) U.S. Cl. CPC H04L 67/18
USPC 709/204

(57) ABSTRACT

An approach is provided for creating a connection between users of a social network. The approach involves determining location information associated with a user and other location information associated with one or more other users. The approach also includes processing the location information and the other location information to cause, at least in part, identification of one or more encounters, one or more encounter patterns, or a combination thereof with respect to the user and the one or more other users. The approach further includes determining to generate at least one recommendation to create at least one social network, at least one social networking relationship, or a combination thereof between the user and at least one of the one or more other users based, at least in part, on the one or more encounters, the one or more encounter patterns, one or more meetings and/or events, or a combination thereof.

### BACKGROUND

Service providers (e.g., wireless, cellular, etc.) and device manufacturers are continually challenged to deliver value and convenience to consumers by, for example, providing compelling network services. One area of interest has been the development of social networking services for building connections and forming social networks among groups of users. As the popularity of such services increase, users can find it more difficult or burdensome to build or maintain networks as the potential number of contacts grows. As a result, service providers and device manufacturers face significant technical challenges to facilitating the discovery of potential social networking contacts and then the formation of relationships or networks based on those discovered contacts.

### SOME EXAMPLE EMBODIMENTS

Therefore, there is a need for an approach to suggest and/or create social networking connections.

According to one embodiment, a method comprises determining location information associated with a user and other location information associated with one or more other users. The method also comprises processing and/or facilitating a processing of the location information and the other location information to cause, at least in part, identification of one or more encounters, one or more encounter patterns, or a combination thereof with respect to the user and the one or more other users. The method further comprises determining to generate at least one recommendation to create at least one social network, at least one social networking relationship, or a combination thereof between the user and at least one of the one or more other users based, at least in part, on the one or more encounters, the one or more encounter patterns, or a combination thereof.

According to another embodiment, an apparatus comprises at least one processor, and at least one memory including computer program code, the at least one memory and the computer program code configured to, with the at least one processor, cause, at least in part, the apparatus to determine location information associated with a user and other location information associated with one or more other users. The apparatus is also caused to process and/or facilitate a processing of the location information and the other location information to cause, at least in part, identification of one or more encounters, one or more encounter patterns, or a combination thereof with respect to the user and the one or more other users. The apparatus is further caused to determine to generate at least one recommendation to create at least one social network, at least one social networking relationship, or a combination thereof between the user and at least one of the one or more other users based, at least in part, on the one or more encounters, the one or more encounter patterns, or a combination thereof.

According to another embodiment, a computer-readable storage medium carries one or more sequences of one or more instructions which, when executed by one or more processors, cause, at least in part, an apparatus to determine location information associated with a user and other location information associated with one or more other users. The apparatus is also caused to process and/or facilitate a processing of the location information and the other location information to cause, at least in part, identification of one or more encounters, one or more encounter patterns, or a combination thereof with respect to the user and the one or more other users. The apparatus is further caused to determine to generate at least one recommendation to create at least one social network, at least one social networking relationship, or a combination thereof between the user and at least one of the one or more other users based, at least in part, on the one or more encounters, the one or more encounter patterns, or a combination thereof.

According to another embodiment, an apparatus comprises means for determining location information associated with a user and other location information associated with one or more other users. The apparatus also comprises means for processing and/or facilitating a processing of the location information and the other location information to cause, at least in part, identification of one or more encounters, one or more encounter patterns, or a combination thereof with respect to the user and the one or more other users. The apparatus further comprises means for determining to generate at least one recommendation to create at least one social network, at least one social networking relationship, or a combination thereof between the user and at least one of the one or more other users based, at least in part, on the one or more encounters, the one or more encounter patterns, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-28 and 48-50.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing a suggestion to create a social network and/or to suggest a social networking connection, according to one embodiment;

FIG. 2 is a flowchart of a process for suggesting creating a social network or a social networking connection, according to one embodiment;

FIG. 3 is another flowchart of a process for providing a suggestion to create a social network and/or to suggest a social networking connection, according to one embodiment;

FIG. 4 is a flowchart for providing a user interface for presenting a suggestion to create a social network and/or to suggest a social networking connection, according to one embodiment;

FIG. 5 is an illustration of a user interface having controls for setting preferences, according to one embodiment;

FIGS. 6a and 6b are illustrations of user interfaces for displaying recommended social networking connections, according to various embodiments;

FIG. 7 is an illustration of a user interface for displaying recommended social networking suggestions and notification pop-ups, according to one embodiment;

FIG. 8 is an illustration of a series of user interfaces for creating an event, according to one embodiment;

FIG. 9 is an illustration of user movement at a location, according to one embodiment;

FIG. 10 is an illustration of a user interface for controlling preferences about an event and social networking connections, according to one embodiment;

FIG. 11 is an illustration of a user interface that notifies a user of an event and enables the user to view other attendees of the event, according to one embodiment;

FIG. 12 is an illustration of a user interface that displays choices for adding suggested social networking connections to a social networking service, according to one embodiment;

FIG. 13 is an illustration of how event information may be displayed on a user's social networking service profile, according to one embodiment;

FIG. 14 is a diagram of hardware that can be used to implement an embodiment of the invention;

FIG. 15 is a diagram of a chip set that can be used to implement an embodiment of the invention; and

FIG. 16 is a diagram of a mobile terminal (e.g., handset) that can be used to implement an embodiment of the invention.

### DESCRIPTION OF SOME EMBODIMENTS

Examples of a method, apparatus, and computer program for creating an ephemeral social network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

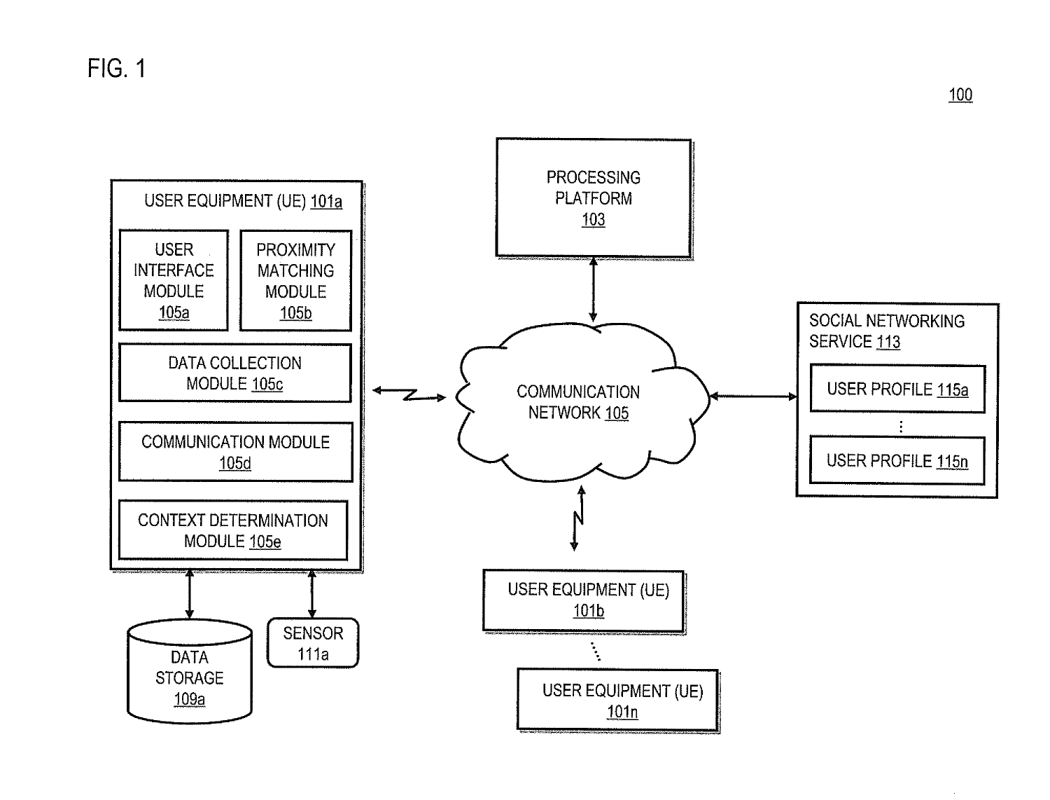

FIG. 1 is a diagram of a system for suggesting creation of a new social network or a connection between users of a social networking service, according to one embodiment. Traditionally, building a contact list of social network connections is structured and often involves the burden of explicitly inviting or being invited to join a social network. However, this traditional approach often does not reflect typical social interactions that occur in the real or physical world (as opposed to the virtual world of social networking services). For example, real-world physical interactions are typically built and grown at the point of contact at a specific place during an activity (e.g., a meeting, gathering, etc.). Generally, such physical interactions (e.g., “physical or real-world social networks”) are created temporarily (e.g., only for the duration of an event or meeting), in an ad-hoc manner, and are ephemeral for the activity, place, and/or time. Such a real-life, physical, social network is also known as an ephemeral social network. When a person creates an ephemeral social network, questions like “how do I know this person?,” “who was that person in the meeting?,” “where are my friends so I can join them for lunch?,” “what restaurants are nearby that my friends recommend?” may be asked.

However, there often is a lag in recording or translating these physical social interactions to electronic social networking services because users often have to manually create records (e.g., post to social networking services, create new social networking relationships, etc.) of the physical event after the physical interaction or activity has been completed. These manual recording activities can be prone to human error and/or forgetfulness. In addition, users face the added burden of manually collecting new friends and sending out friend invitations at a later time. As such there is a need to create an online social networking experience that is like the ephemeral social networking experience by creating a social network reminiscent of the physical environment such as a network based on an event, and/or gathered ephemeral offline activities and physical interactions in physical environments.

It also may be advantageous to suggest a social network connection to a user based on a location of the user or a shared experience or an encounter of the user with other users. Generally, a user may feel more comfortable to request a connection with other users who are within a proximity with the user, share something in common, than with complete strangers. For example, people typically have more confidence in connection suggestions for family, friends and acquaintances for fear of rejection or other personal reasons. But, if a suggestion to make a social network connection is based on other pretences and an explanation of the suggestion is provided to the user, the user is more likely to proceed with building his social network by way of the suggested connection experience.

To address this problem, a system 100 of FIG. 1 introduces the capability to create an ephemeral social network based on, for instance, people (e.g., devices and their users) that are at a detected event, and then synchronizing or recording the ephemeral offline interactions and activities (e.g., through events) to an online social network. In one embodiment, the online ephemeral social network mirrors the physical ephemeral network described above. In other words, an online ephemeral social network is a social network of people that is created at a particular point in time for a temporary period at a particular place or a particular event, and that is then stored in an online social network either temporarily or permanently. An example of an ephemeral social network is the social network created during the meetings that a person may have with other people in meeting rooms. Such an example of an ephemeral social network is a snapshot of a point in time or time slice of the entire social network where a particular activity happened at a particular place. In this way, the system 100 enables place-based activity social networking as discussed with respect to the various embodiments described herein.

In one embodiment, the ephemeral social network is used as the interface and mapping between online and offline social networks. In yet another embodiment, the ephemeral social network is an annotation and enhancement of the online social network and is an entity that is a subgraph in time of the entire social graph of the online social network.

In one embodiment, the system 100 creates or suggests the creation of the ephemeral social network by determining a location of a user based on the user's physical location or his attendance at an event, suggesting a connection with another user, and/or presenting a reason why the connection is being suggested to user. The system 100 may also be capable of suggesting that a social network be created for a group of users that have similar interests, encounters, similar patterns of activity, overlapping schedules, and the like.

In one embodiment, the system 100 determines the location of the user based on the location of a user device. For instance, a user equipment (UE) or device 101a may detect other UE's or devices 101b-101n that are connected by way of a communication network 105. The other devices 101b-101n may be set as candidate devices. The candidate devices are each assigned to a user of a social network 113 to which the user also belongs. As a result of the devices 101b-101n being within a particular proximity of the device 101a, the system may suggest that a social networking connection be made between the users to which the devices 101a-101n are assigned. The system 100 may also suggest creating an ad-hoc social network between the detected devices even if the users are not all members of the same social networking service.

By way of example, the system 100 enables a device 101a user to detect other potential connection candidates associated with other device 101b-n users via a processing platform 103. The other device users may be associated with the user of device 101a in various ways, including mutual affiliation with a particular contact list or group, common social network or online community membership, attendance at an event, a particular proximity to one another, an overlap of time spent in a location, a series of repeat encounter patterns, or the like. The location of the user may not be limited to just detection of the location of the devices 101a-101n, but also may be determined based on any combination of an event calendar that is resident in the user's social networking profile, personal calendar, any event to which the user has been invited or RSVP'ed, or any announcement that the user has been invited or is planning on attending an event such that the information is available through at least one network interface.

In certain embodiments, the processing platform 103 is implemented as a collection of a hardware, software, firmware or combinations thereof that can be integrated for use with a social networking service 113 accessible by UEs 101a-n. By way of example, the processing platform 103 can be maintained on a server, while operating in connection with the social networking service 113 as a webservice, applet, script, object-oriented application or the like for enabling search processing to be performed directly from one or more devices. In this way, the processing platform 103 and social networking service 113 may present a common, integrated interface, through which location and encounter information may be processed. It is noted that the processing platform 103 may be implemented as an extensible feature of the social networking service 113, while in some instances, may be implemented as a separate service.

In certain embodiments, as discussed above, the other users that operate respective UE 101b-n can be associated with the user of UE 101a through the social networking service 113. In this scenario, the user of UE 101a may be registered with the social networking service 113 as a member, maintaining a distinct user profile 115a. Likewise, users of respective UEs 101b-n also maintain profiles, e.g., profile 115n. The profiles 115a-n may be data files containing profile information for distinctly specifying, classifying and/or identifying users. Profile information may include the user's name, age, address, phone number, e-mail address, occupation, hobbies, interests, organizational affiliations, activities of engagement, etc. The profile information may also establish linkages the user shares with others within the context of the social network 113 such as virtual group affiliations, personal contacts, friendships, online communities and interest groups, and past communication exchanges with other members (e.g., threaded messages). Still further, communication settings, data access restrictions, communication protocols, processing platform 103 settings, etc., may also be indicated in the user profile 115. The social networking service 113 provides a common interface that enables users to interact with one another to establish friendships, communicate, access common applications and features, identify friends-of-friends, share files, etc. It is noted that the user profile 115a-n can be optionally maintained within data storage 109a of respective UE 101a-n for facilitating a social networking session with other users through the service 113.

Still further, in certain embodiments, “context” may pertain to real-time or historical interactions that occur between a user and their respective UE 101. It is noted that how a person uses a device can be examined to show specific patterns that represent that user's behaviors or tendencies relative to a given activity, and hence, the activity may be placed into context. The current way in which the user interacts with their device may also provide a reason for matching users and suggesting a connection. For example, if the user is exercising on a treadmill, this activity may provide additional context information pertaining to the user enabling it to be directed to the processing platform 103 and matching appropriate other users that may be working out at a gym at the same time, at a different time, at the same location, or any other location where another user may also be exercising, for example. Also, by way of example, some mobile devices 101a keep records of a user's interactions with their device at given moments, such as when the user engages the device for: (1) communicating via text messaging or e-mail (e.g. through maintenance of a communication log/history); (2) playing media files or streaming data; (3) social networking; (4) using certain applications; etc. Data is recorded, therefore, as “context information,” which pertains to any data indicative of the current activity the user is engaged in with respect to the device. It is noted that the processing of matching other users as possible connections is enhanced when more context information is provided for rendering a decision.

In general, context information refers to, at least in part, all contextual data, user data and user-to-device interaction data (e.g., date, time of day, location, activity, motion, position, modality, spatiotemporal element, etc.) as collected, and is particularly useful for determining a present state or modality of the device. In addition, context information can be determined through analysis of historical data pertaining to the user or device, so as to enable a means of predicting to a degree to certainty expected or future device states or modalities. For example, if it is observed that a user frequently executes a music player during the early morning hours of the day, this information can be utilized for determining or defining a context relative to the user based on this tendency (e.g., context=workout time). Hence, the compilation of context information can be analyzed appropriately, including referenced with respect to additional data and/or a context model, for enabling the context of a device, device user or one or more other associated users and their respective devices to be determined accordingly.

By way of example, in certain embodiments, context information may also include data transmitted during an instance of device engagement with the social networking service 113 over the communication network 105. Also, by way of example, context information may pertain to any data gathered by one or more sensors 111a of the device, said data representing sensory phenomena useful for characterizing the present moment interaction between the device and one or more devices, objects or users. Exemplary sensors 111 may include, but is not limited to, a sound recorder, light sensor, global positioning system (GPS) and/or spatio-temporal detector, temperature sensor, motion sensor, accelerometer, gyroscope, camera and/or any other device for perceiving sensory and environmental phenomena. Objects for which the device may interact may include, but is not limited to, other user devices (e.g., cell phones), peripheral devices such as Bluetooth headsets, keyboards and server devices or entities within the immediate environment or context of use such as buildings, landmarks, machines, vehicles or people.

In certain embodiments, the UE 101 may include various executable modules 105a-105e for interacting with the processing platform 103, as well as perform one or more useful device actions relative to engaging the social networking service 113. While not shown expressly, each of the one or more UE 101a-101n may also be configured in the same fashion or alternatively, feature only some of the exemplary modules 105a-105e if any. The exemplary modules of the UE 101a include a user interface module 105a, a proximity matching module 105b, a data collection module 105c, a communication module 105d and a context determination module 105e.

In certain embodiments, the exemplary modules 105a-105e may be stand-alone modules or they may also be integrated into any of the processing platform 103 or the social network 113.

The user interface module 105a, by way of example, enables presentment and personalization of the social networking service 113 to the interface of their respective UE 101 in conjunction with the processing platform 103. Through the user interface module 105a, users can view and update their user profiles, such as by accepting a suggested connection and viewing an explanation of why the connection was recommended to the user. To notify the user that there is a friend recommendation when the user moves to a certain place where the user has a frequent encounter pattern with one or more other users, or a event shared with the one or more other users, the notification may show why this user is recommended on a physical map to illustrate where the frequent encounter pattern or meetings/events shared together are found. The user interface module 105a may also show when the frequent encounter pattern or the meetings/events are happening, what is going on during the frequent encounter pattern or the meetings/events, and/or who is involved in the frequent encounter pattern or the meetings/events, together with the information of similar profile or network structure such as the shared interests and skills and common friends, if any. In other words, the user interface module 105a may display a map of an area that corresponds to the user's location and illustrates where other potential connection candidates may be positioned with respect to the user location on the map, or simply illustrate that a potential connection was made at a particular location and that the connection is now being suggested. It is noted that the user interface module 105a provides a means of interaction between the user and the various executions and features of the processing platform 103 and social networking service 113 by way of a keyboard, virtual keypad, stylus, or other data input mechanism. Any capabilities afforded by the particular social networking service 113 may be rendered to the display of UE 101 by way of the user interface module 105a.

Operable in connection with the user interface module 105a, in accordance with an embodiment, is the communication module 105d. The communication module 105d allows users to manually input location information as well as select other users within their contact network that are suggested connection to engage with. The input is sent to the processing platform 103 for processing, so as to determine a suggested connection with other users of the social networking service 113. The input may also be used in a system wide determination for suggesting that an event be created or that the user attend an event based on other user information.

According to an embodiment, a proximity matching module 105b determines whether the profile of a user of a UE 101b-n that is within proximity to the user of UE 101a and is contextually relevant to the user of UE 101a. In certain instances, the user of UE 101a may store preferences such as a predetermined range within which other users may be detected for matching or a predetetuiined time period during which an encounter may last such as a time overlap, or a duration that the connection may last, such as the duration of an event.

The proximity matching module 105b may be configured to detect temporary short-range connections between devices within range of one another, i.e., via Bluetooth. Still further, the proximity matching module 105b can retrieve potential connections as stored to cache of the UE 101a for comparing it against profile information pertaining to the devices within range of it. When a match is detected, the proximity matching module 105b generates an alert to the user of UE 101a to indicate the other users of UE 101 and suggest a connection.

According to an embodiment, a data collection module of the UE 101a periodically collects the context information generated by a UE 101 associated with respective users, including information descriptive of a date, a time, a location, a relationship, an activity, device usage or a combination thereof relative to a particular user of UE 101. The aggregation of context information by the data collection module 105c may be used to support the context recognition and determining capabilities of a context determination module 105e and provide a further basis for the system 100 to suggest a connection between users of the social network 113.

According to an embodiment, the context determination module 105e determines an actual context of the user or respective device based on the context information as gathered by the data collection module 105c. The context is characterized by context determination module 105e according to a context model. A “context model” may specify any data type definitions, associated data structures and/or schema for representing an object, interaction, event, process or combination thereof relative to the user or UE 101. In particular, the context model indicates the classifier types, identifiers and object types, associated expected input data types and the expected response or output data types for the context being modeled (e.g., a system, an event or object based context). Furthermore, the context model indicates the relationships between the data sets and data types of which it is comprised. Still further, the context model may also define one or more object-oriented, abstract or conceptual elements that in combination, characterize the behavior of an underlying system, object, interaction, event or process. It is noted that the various known approaches to generation of a context model are within the scope of the embodiments as presented. As a general approach, the context model can be designed and trained initially through various data conceptualization techniques.

It is noted that the context information collected by the data collection module 105c may be used for comparison against data maintained in a user profile in order to determine an extent of relevance between a particular user context, their profile and a connection candidate. In other instances, the context determination module 105e may operate in connection with the proximity matching module 105b for determining if a user of UE 101b-n within range of an inquiring user of UE 101a is suited for being a social networking connection. In other instances, once the status (context) of a user deemed to be a good match to another user, the context determination module 105c updates the processing platform 103 accordingly, and the system 100 suggests a connection.

In one embodiment, the processing platform 103 compiles all of the information that is known about the user and the other users to determine whether an event, social network, or social networking connection should be suggested. Such a determination may be based on a number of attributes such as context information, as discussed above, whether it be sensed by the UE 101a-101n, or other modes of detection, web context data about the users, social network data and/or event data. The information is compiled using various algorithms to determine activity and encounter information about the users, and score the information in a weighted fashion so that a determination is made as to whether a social networking connection should be suggested to the users. The social networking connection suggestion may be any of joining an ad-hoc network, making a connection on a social networking service, or simply attending an event.

In certain embodiments, a first user's activity and encounter information is weighted and scored by first setting a recommendation score of recommending a second user as a potential social networking connection as “0.” Then, the processing platform 103 determines the number of frequent encounters to determine a number of frequent encounter patterns of the first and second users. The processing platform 103 denotes the number of frequent encounter patterns as Num Frequent Encounter Pattern. Next, the processing platform 103 gathers the number of meetings and/or other physical events that the two users share together and denotes the meetings and/or physical events as Num_Meeting_Event_Together. In one embodiment, if Num_Frequent_Encounter_Pattern+Num_Meeting_Event_Together >0, then the processing platform 103 calculates a recommendation score using the equation:

recommendation score =(Num_Frequent_Encounter_Pattern* Weight_Encounter_Pattern)+(Num_Meeting_Event_Together *Weight_Meeting_Event_Together)

where (Weight_Encounter_Pattern +Weight_Meeting_Event_Together)=1.
Otherwise, the process for calculating and storing a recommendation score is ended. But, should the processing platform 103 determine that a score should be generated, the score is stored and related information about the frequent encounter pattern, meeting/event together, plus with similar skills and common friends is also stored in a database. The processing platform 103 may also calculate a value based, at least in part, on a similarity of at least one profile to another profile and a network structure such as similar interests, common friends, etc. to generate a score based on the calculation of the similarity of the profiles and the network structure. This score may be used in generating the recommendation. While this score may enhance the recommendation, and place an even higher weight on an already heavily weighted encounter pattern and provide additional reasoning for suggesting the connection, the score involving the similarity of profiles and network structure is merely a way to enhance the recommendation, and is not a requirement.

In certain embodiments, features that may be compiled to determine that an event should be created and scheduled may include encounter situation patterns, dynamic social location information of the one or more users, event announcements on the web, calendar information, and activity information for the one or more users into account, for example. The system 100 may consider all of the features that can be compiled with an event template to detect an event based on all of the information of the users that is available. Event detection indicates that an event has been determined and that the event should be scheduled. If the event is scheduled an event trigger is activated and invitations may be sent out to the one or more users to attend the suggested event.

In one embodiment, the communication module 105d and the processing platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (FLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet,

Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the UE 101 can be a device that simulates or provides a virtual telescope-like function. This type of UE 101 can be, for instance, mounted in a public place (e.g., a shopping center, hotel, etc.) to enable users to view information presented as described herein.

By way of example, the UE 101, processing platform 103 and social networking service 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

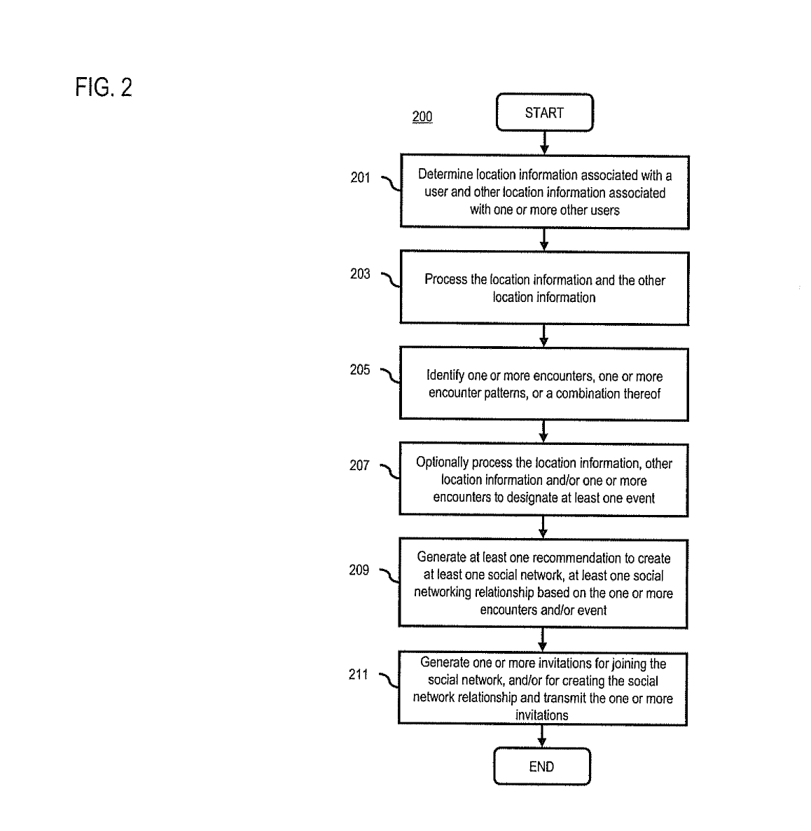

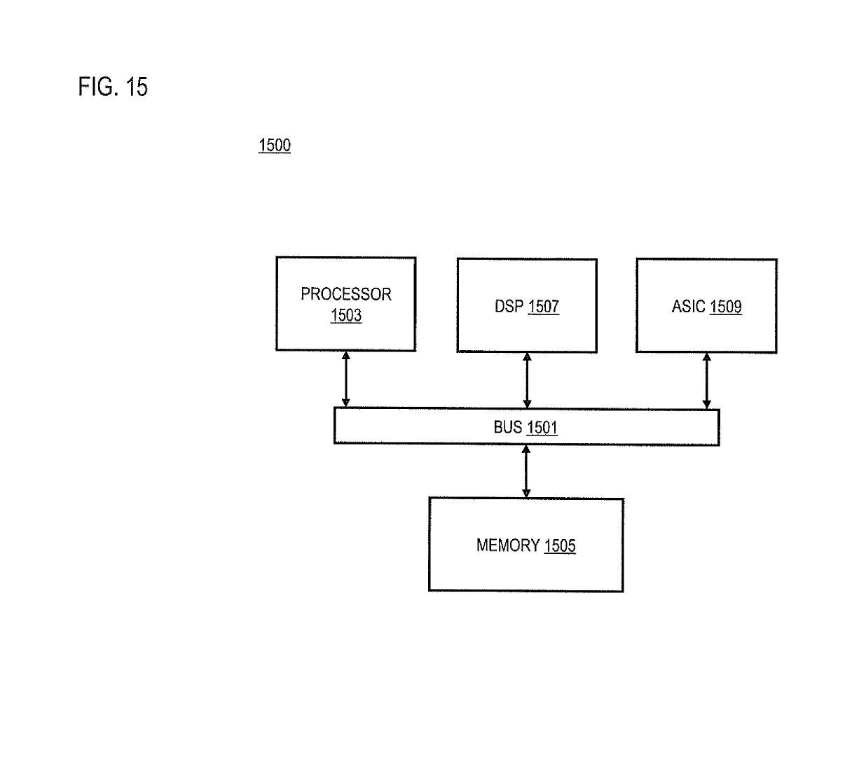

FIG. 2 is a flowchart of a process for creating at least one recommendation for generating a social network or a social networking relationship or connection, according to one embodiment. In one embodiment, a processor 1503 performs the process 200 and is implemented in, for instance, a chip set including a processor and a memory as shown FIG. 15. In certain embodiments, the processing platform 103 may perform some or all of the steps of the process 200 and communicate with the UE 101a-n using a client server interface.

In step 201, the processor 1503 determines location information associated with a user and other location information associated with one or more other users. Next, in step 203 the processor 1503 processes the location information and the other location information to cause, at least in part, identification of one or more encounters, one or more encounter patterns, or a combination thereof with respect to the user and the one or more other users. In step 203, the processed location information is used for identifying encounter patterns and regular interactions for the user and the one or more other users. The encounter type and a context dataset are identified. The system 100 may create an encounter context graph for each encounter type with a context. The encounter context graph is converted to an encounter situation graph using a situation pattern template, which is based on a context “t” and an encounter type. The system 100 may also search for other same situations at other times from which the system may identify encounter patterns.

In step 203, the processor 1503 uses various algorithms to process the location information to determine the one or more encounter patterns, and especially to distinguish between encounter patterns and mere “passer-by” instances. For instance recording background encounters, passbys and meetings may be determined as follows:
Every T seconds, calculate distance D between every possible pair of users A and B that are online and are in the same area with P_{A}=position of user A and P_{B}=position of user B respectively
Let D_{threshold}=distance to be considered as a proximity activity (encounter, passby or meeting) and V_{threshold}=threshold speed
   Calculate the Cartesian distance between two users at two different times, T₁ and T₂ using the formula:

D(T₁)=|P_{A1}−P_{B1}| where |. . . | is the Cartesian distance and P=(x, y) on a 2D map at time T₁

D(T₂)=|P_{A2}−P_{B2}| at time T_{2,}

Users A and B are considered having been near each other if the following holds between T₁ and T₂ (where T is time):

V=|D(T₂)−D(T₁)|<V_{threshold} and D(T₂)<D_{threshold} (1)

|T₂−T₁|

and

D(T₁)>D_{threshold}

Proximity activities are defined as an encounter, passby or meeting are determined by comparing V_{threshold} and D_{threshold} as well as context. User preferences may define thresholds for encounter, passby and meeting, respectively, DU_encounter, DU_passby and DU_meeting. The duration of two users' proximity from one timeslot to another obeys the following three conditions in Eqn. (1) denoted by DU:
If DU<DU_passby, then the proximity activity is a passby
If DU_passby<DU<DU_encounter, then the proximity activity is an encounter
If DU_encounter<DU<DU_meeting, then the proximity activity is a meeting
   If DU_meeting<DU, then the proximity activity maybe invalid so it is removed from consideration. Velocity V is also considered when determining an encounter as follows:
If v>V_{threshold}, then do not record proximity activity for this person
If v_{A}=|P_{A2}−P_{A1}|/|T₂−T₁|>V_{threshold}/2 then remove P_{A2} and P_{A1}
If v_{B}=|P_{B2}−P_{B1}|/|T₂−T₁|>V_{threshold}/2 then remove P_{B2} and P_{B1}
   where V_{threshold} is the threshold speed for the person's physical movement activity. For example, for the most part, when people are walking, V_{threshold} is usually set to 5 m/s to indicate the average human walking speed.

In step 205, the processor processes the location information, and after distinguishing that the encounter is not merely a passby scenario, identifies the one or more encounters, one or more encounter patterns, one or more meetings and/or physical events or combination thereof. The processor may also, in certain embodiments, calculate the distance between two or more encounters by defining a location granularity such as a city, building, or floor, and denote the location of a first user and a second user during a first encounter such as LOCATION_1_A and LOCATION_1_B, and LOCATION_2_A and LOCATION_2_B during a second encounter. If the two encounters happened within the predetermined granularity, a central point of the two users in the first encounter and the second encounter may be determined by finding a mid-point between all of the locations. Once the central point is determined, the processor may determine the distance between the encounters and the central point as a Euclidean distance of LOCATION_1 and LOCATION_2. If the two encounters do not fall within the predetermined granularity, the distance of the two encounters may be set as infinity.

Next, in step 207, the processor optionally processes the location information, the one or more encounter patterns, or a combination thereof to cause, at least in part, a designation of at least one event. In other words, when it is determined that there is a pattern of encounters, or a close proximity of multiple users, perhaps with similar interests, the system 100 may suggest that an event be designated and an invitation be sent to each of the user and the one or more other users. The suggestion may also be to suggest that the user and the one or more other users form a social network among themselves, or become connected on a pre-existing social network to which the user and the one or more other users are already members.

In certain embodiments, a basis for suggesting a connection based on an encounter pattern may be based on a determination of whether the encounter occurs within a particular frequency. The processor may use an algorithm to determine a list of new encounters such as: If the two users have any new encounter with status !=HAVE_BEEN_PROCESSED and DATETIME>DATETIME of the encounter and DATETIME<DAYS_FREQUENT+DATETIME of the encounter, then select a new encounter from the list determined encounters, which may be sorted by DATETIME. A new location of the users may be determined, and if the distance of the two users is less than a distance encounter threshold DISTANCE_ENCOUTNER_THRESHOLD, then the number of times that encounter occurs again between the users is increased and stored.

The process continues at step 209 where the processor 1503 causes the recommendation to create at least one social network or a social networking connection to be based on the at least one event. For example, if the user is attending a seminar where there are other attendees, a suggestion may be created to connect any or all of the attendees at the event by way of a temporary or permanent event specific social network, or to connect any or all of the attendees by way of another social networking service that the attendees all belong to. Next, the process continues to step 211 where one or more invitations to join a social network, form a social networking relationship, and/or to attend an event are generated.

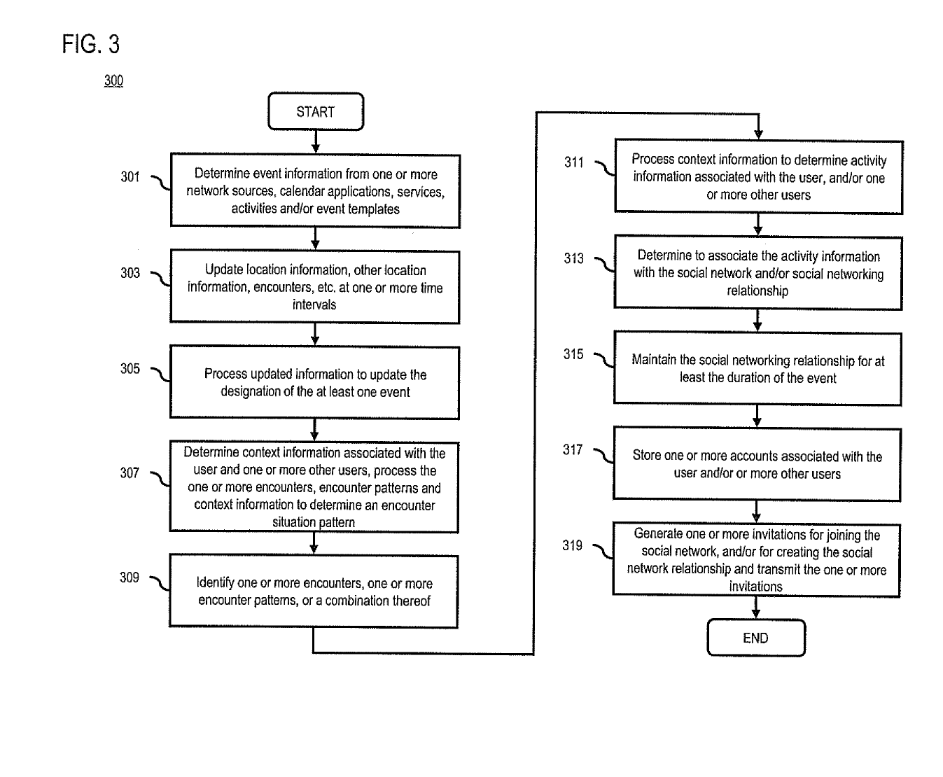

FIG. 3 illustrates a process 300 for determining to suggest an event and for how long to maintain a social networking relationship based on the event, according to one embodiment. In one embodiment, a processor 1503 performs the process 300 and is implemented in, for instance, a chip set including a processor and a memory as shown FIG. 15. In certain embodiments, the processing platform 103 may perform some or all of the steps of the process 300 and communicate with the UE 101a-n using a client server interface.

The process starts at step 301 with determining event information from one or more network sources, one or more calendar applications or services, one or more activities, or one or more event templates. For instance, a user may have a calendar full of events or planned activities that may coincide with similar events or activities that are planned to occur on another user's calendar. Based on this information, an event may be designated, and a social networking connection may be suggested to the user and the one or more other users that have overlapping events or activity planning. Similarly, the event designation information may be drawn out of any network source such as a publication of attendance or simply an invitation to attend an event. The event information may be used for identifying encounter patterns and regular interactions for the user and the one or more other users at step 303. Next, at step 305, the location information and other location information, or encounter patterns, etc are updated at a predetermined time interval. The time interval for updating may be set by way of a user preference. The location information, however, may also be manually updated by a user, whether the location information that is input be at a time in the past, present or future. The location information, therefore, need not be limited to the present location of the user, but may be a place the user intends to be, or may simply be interested in. Next, the updated location information is processed such that the designation of the at least one event is also updated (step 307).

The process optionally continues to step 309 where context information associated with the user and the one or more other users are determined and the context information, along with the one or more encounters, encounter patterns are processed based on an algorithm that weighs each attribute on a level of importance to determine an encounter situation pattern. The encounter situation pattern, for example could be a situation where one user takes a particular route to the market once per week. Another user takes the same route to the market one per week, at the same time, a different time, or another day. By evaluating the context information and the encounter patterns for each user, an encounter situation is determined which would give rise to a reason for suggesting a network connection between the two users.

Next, the process optionally continues to step 311 where the context information is further processed to determine activity information associated with the user and/or the one or more other users. Continuing with the above market example, based on the context information, a user may develop a pattern of shopping in the produce section of a supermarket. Based on this activity, the process continues to step 313 in which a suggestion may be made to the user that proposes a connection with another user that also likes shopping in the produce section of the same or different supermarket. The process continues to step 315 where a determination is made to maintain the social networking relationship for the duration of the event or for beyond the duration of the event.

The process continues to step 317 where one or more invitations to join a social network, form a social networking relationship, and/or to attend an event are generated. Next, process optionally continues to step 319 in which the social network and/or the social network connection is stored in at least one of the user and the one or more other user's accounts.

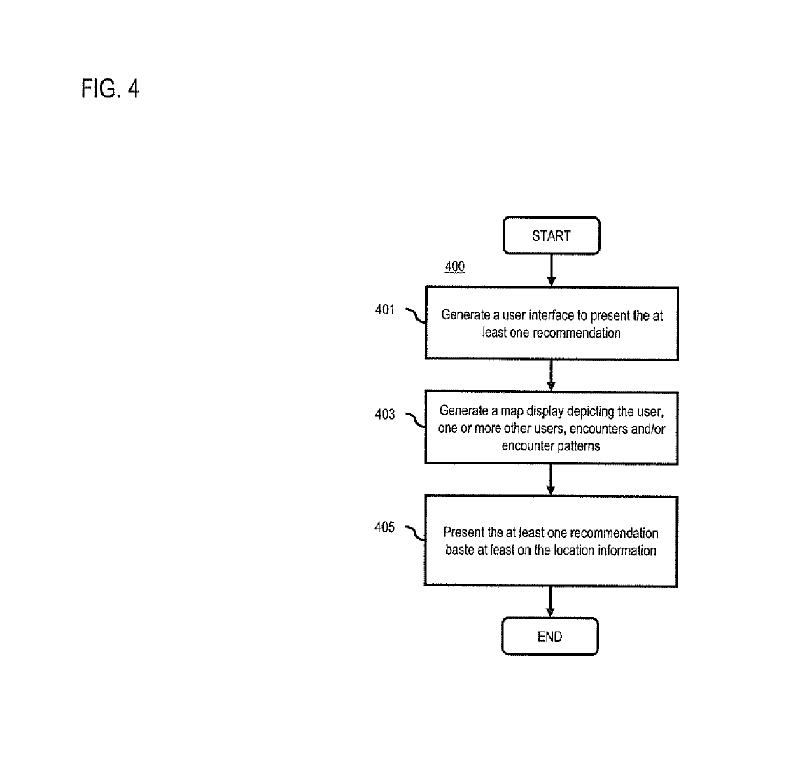

FIG. 4 illustrates a flowchart of a process 400 for generating a user interface display and presenting at least one recommendation for creating a social network or a social networking connection, according to one embodiment. In one embodiment, a processor 1503 performs the process 200 and is implemented in, for instance, a chip set including a processor and a memory as shown FIG. 15. In certain embodiments, the processing platform 103 may perform some or all of the steps of the process 200 and communicate with the UE 101a-n using a client server interface.

The process begins at step 401 in which a user interface is generated to present a recommendation to create a social network or to form a social networking connection with another user. This notification may be any of an SMS message, a pop-up notification, an email, or other electronic means for delivering such a notification. The notification may also be instantaneous or delayed to a time when the user is actually present in a particular location or in attendance at an event. The notification may also be delayed such that it is only initiated by a user on demand.

Next, the process optionally continues to step 403 in which a map display is generated on the user interface to illustrate where potential network connections may be located with respect to the user's current, expected, or suggested location. The map display may also illustrate patterns of behavior of which the user may have a particular interest in search for connections based on that detected behavior. For instance, the user prefers to workout at a gym in the evening and moves from a cardio section to a free weight section during particular times on a particular schedule. If the user would like to find a workout partner based on his activity patterns, the system could search for other users with similar activity patterns and return results of users in the proximity that the user might like to meet or be connected to in the social network. Such an activity may also be represented in the context of attending various events or trade shows, for instance.

The process continues to step 405 where the at least one recommendation to create a social network or faun a social networking relationship is presented to the user based on the location information, at which point the process may end or repeat beginning or ending at any step in the process, whichever is optimal to occur at any given time.

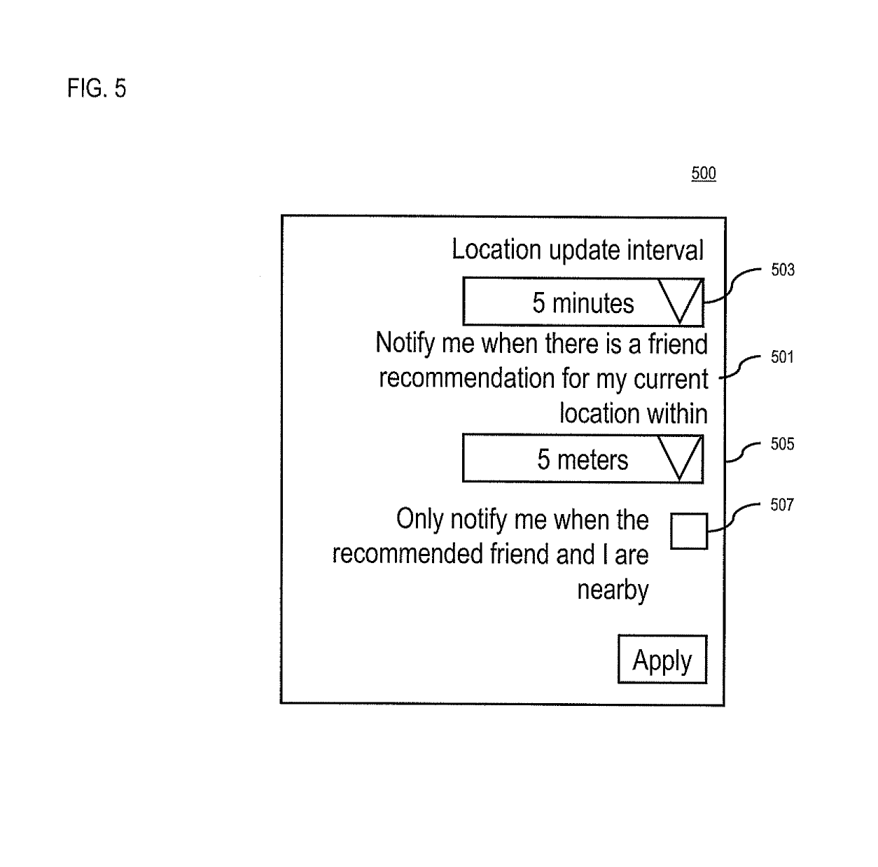

FIG. 5 is an illustration of one embodiment of a user interface 500 that presents a preferences menu 501, according to one embodiment, The user preferences menu 501 enables a user to select preferences to change a predetermined time interval for updating location information by using toggle 503. The toggle 503 may be used to dictate when step 303, discussed above, is accomplished. Toggle 505 may be used for changing a search radius for limiting the range of the search for potential connection candidates by using toggle 505. The toggle 505 may be a way for the user to limit the scope of determining location information associated with one or more other users as discussed with respect to step 201, above. The preferences menu 501 may also be used by the user to limit when step 303 occurs because it also allows the user to limit a suggestion from occurring to a particular moment when the user and the one or more other users are within an even closer proximity than the search radius.

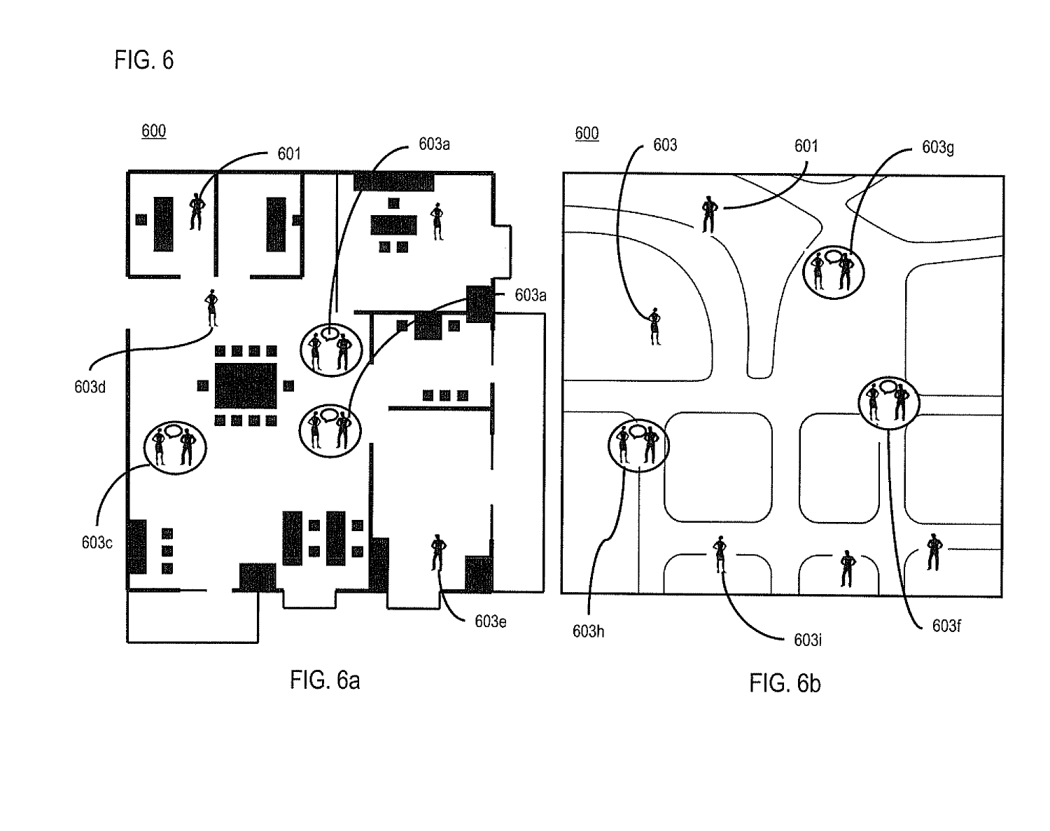

FIGS. 6a and 6b are illustrations of indoor and outdoor mapping displays on a user interface 600 that may show where a user may find networking opportunities based on location information of the user and/or the one or more other users, according to various embodiments. The user interface 600 may be generated during process 400, discussed above. In FIG. 6a, a user 601 is located inside an area of a building. The user 601 may have encounters or encounter patterns, or simply may be in a proximity with other users at locations 603a-e. The user 601 may look at the user interface and either walk to meet the potential connections and form a social network connection in person by making friends, or bumping user devices, for example, or by simply selecting a location 603a-e. The friend recommendation is generated and presented on the user interface in steps 401-405, discussed above. Once the locations 603a, for example is selected, a greater detailed display may be presented that offers more information about the suggested connect. FIG. 6b illustrates an outdoor map that shows a user 601 and his proximity to other encounters and potential connections 603f-j. The outdoor map is merely exemplary and the range may be increased or decreased depending on the user 601's preferences that may be set on another user interface. The map may also be shifted to any location that the user desires and is not limited to the user 601's current location.

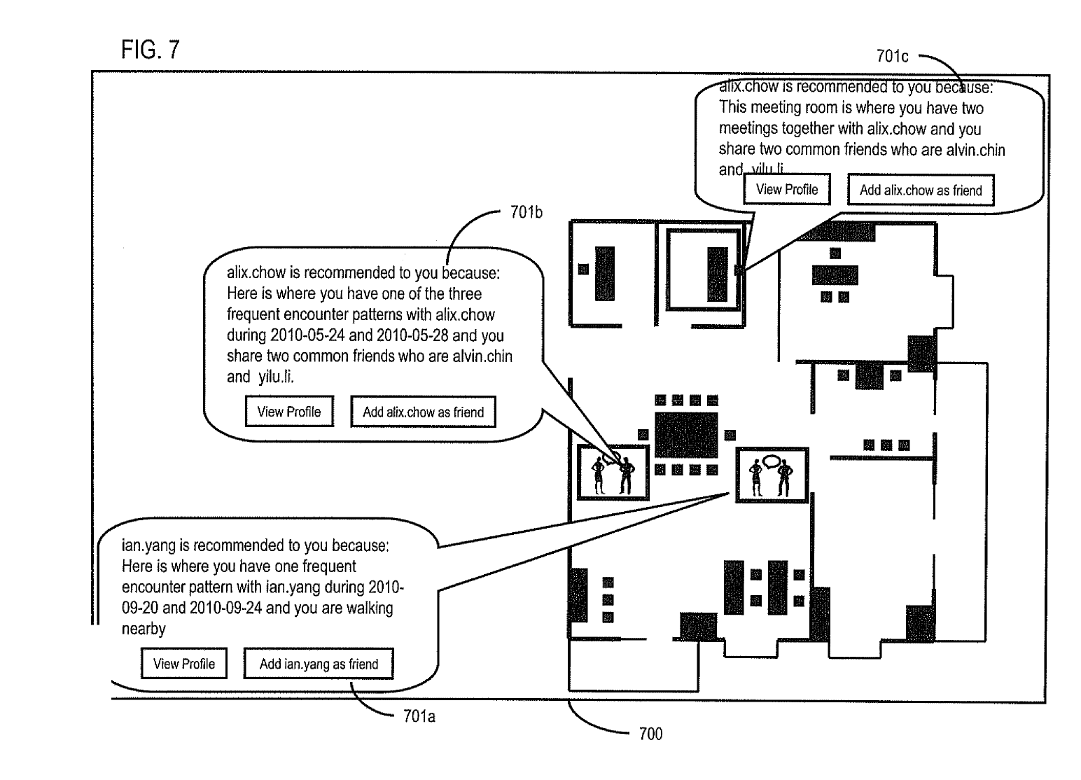

FIG. 7 is an illustration of a user interface 700 depicting an indoor map, according to one embodiment. The user interface 700 shows where an encounter between a user and another user. Based on the encounter and location information, pop-up notifications 701a-c are displayed to the user that suggest a social networking connection to the user and explains why the connection is being proposed. This is beneficial because users would like to know why a social networking service that they belong to are suggesting connections to them. Because the users, in this example, have knowledge about how they know they proposed connection, the users are more likely to accept the suggestion. The user interface 700 is generated by the process 400, discussed above, Particularly, the map illustration and pop-up notifications for suggested connected occur in steps 401-405.

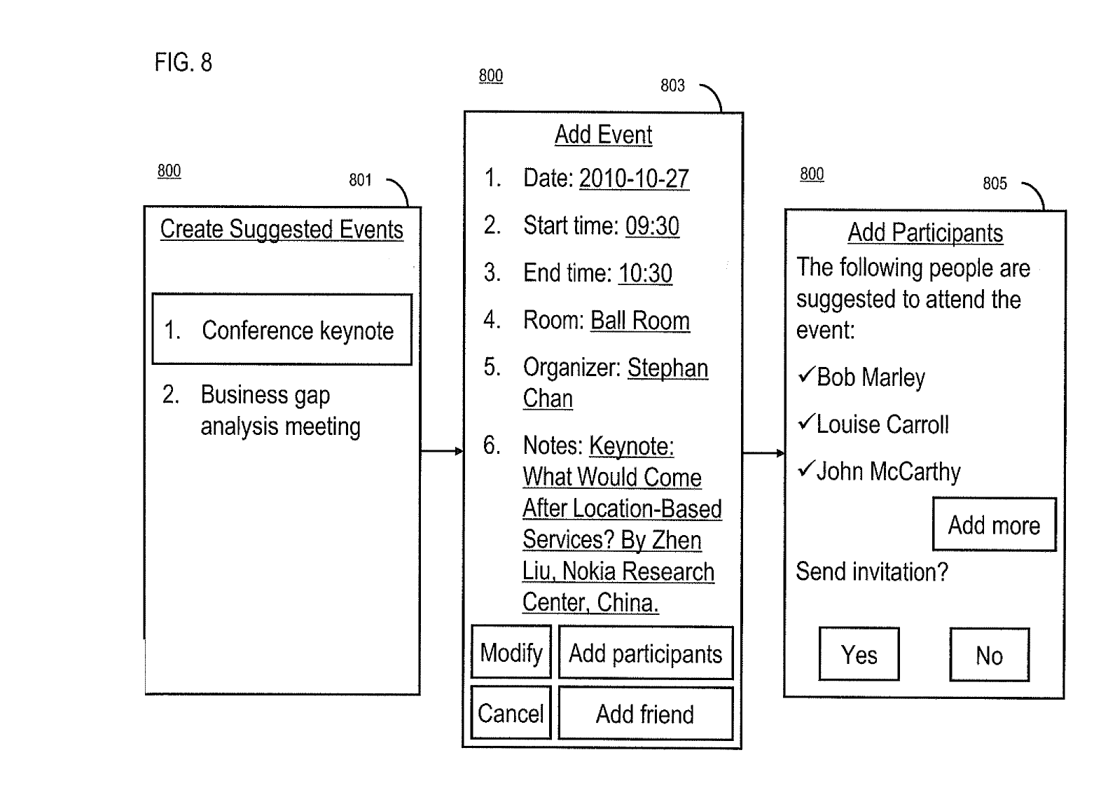

FIG. 8 illustrates an exemplary user interface 800 that shows a series of user interface screens 801-805, according to one embodiment. At user interface screen 801, which may be generated as a result of steps 211 or 319, and in step 405, for example, a display of a suggestion to create an event is shown to the user. The user has the option to view the suggested event. When the user views the suggested event, the user is shown user interface screen 803. User interface screen 803 displays details about the suggested event to the user. The user has the option to add participants to the suggested event and, therefore, create the event. Should the user decide to add participants, the user is shown user interface screen 805. User interface screen 805 displays suggested participants of the event based on those users' location information, context, and encounter information. The user may then add other participants to the event, remove suggested participants, and send invitations to the event.

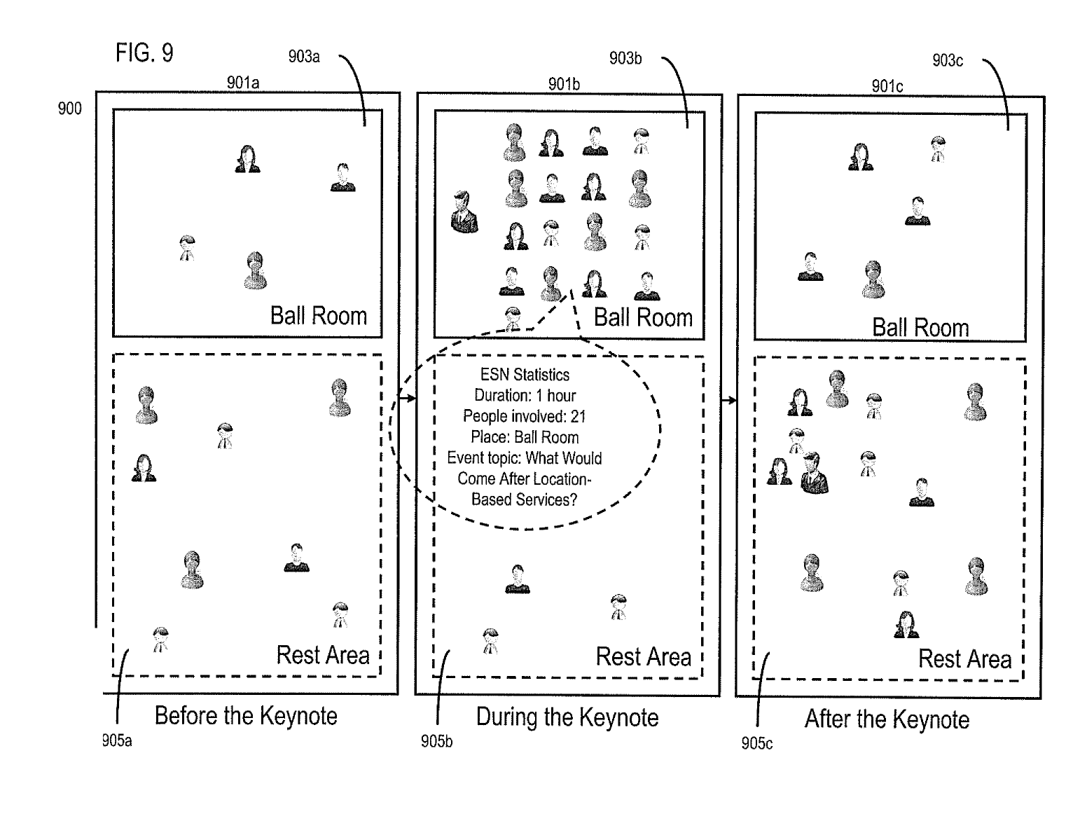

FIG. 9 illustrates a graphical example of how the system 100 may determine that an event has started and ended, according to one embodiment. For example, an event 900 may occur in a proximity 901a-c. The system 100, in this embodiment, detects location information for the user and one or more other users, and determines that the users are scattered between the ballroom 903a and a rest area 905a. The system 100 detects that the majority of users in the proximity 901b are in the ballroom 903b, and fewer users are in the rest area 905b, indicating that the event has started. The system 100, then determines that the event has ended based on location determination of the users in proximity 901c in which the majority of users has left the ballroom 903c and entered the rest area 905c.

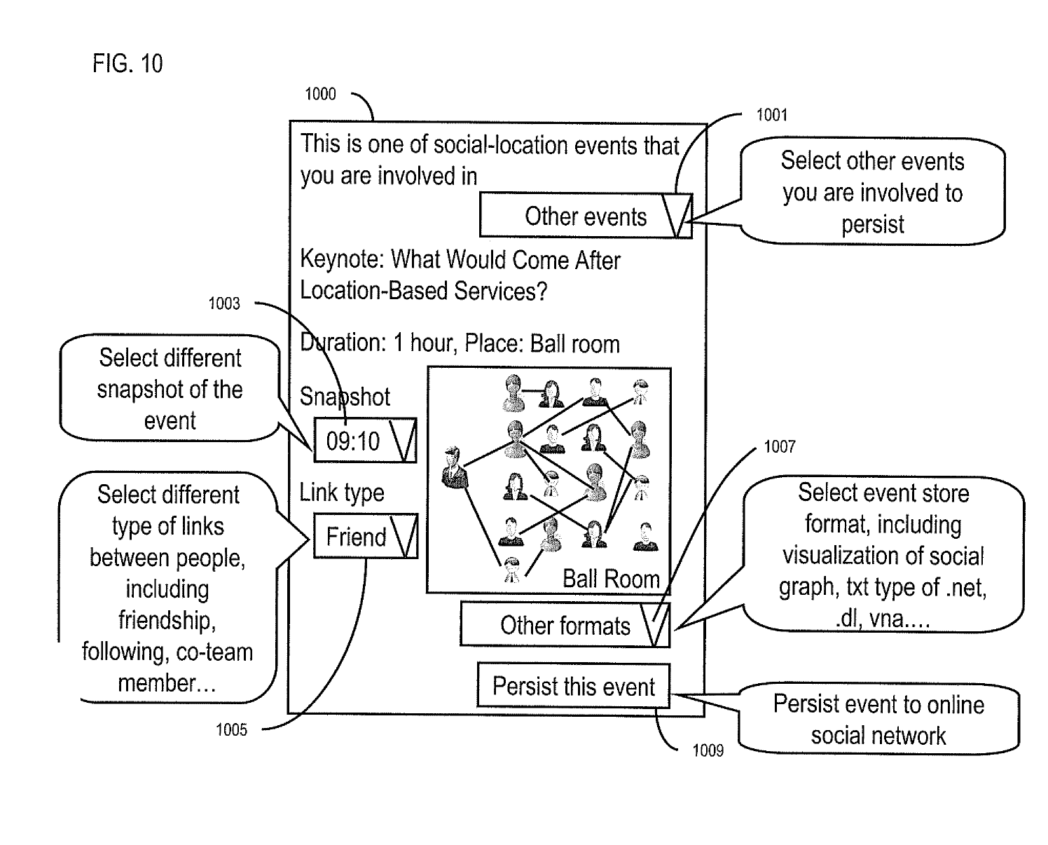

FIG. 10 is an illustration of a user interface 1000 that allows the user to manipulate the information that is shown on the user interface such as selecting the particular event of interest by using drop down box 1001, according to one embodiment. The user interface 1000 may be generated in any of processes 200-400, as invitations to an event and/or at least one recommendation. The user may also specify a particular time of interest for a snapshot of the event using drop down box 1003, and may also specify the link type between members of the event such as friend, co-worker, team member, etc. by specifying as such using drop down box 1005. The user may also specify a format that the event may be saved as in the user's account or other storage using drop down box 1007, and may select how long the network connection is set to last, be it for the duration of the event, or longer based on options in drop down box 1009.

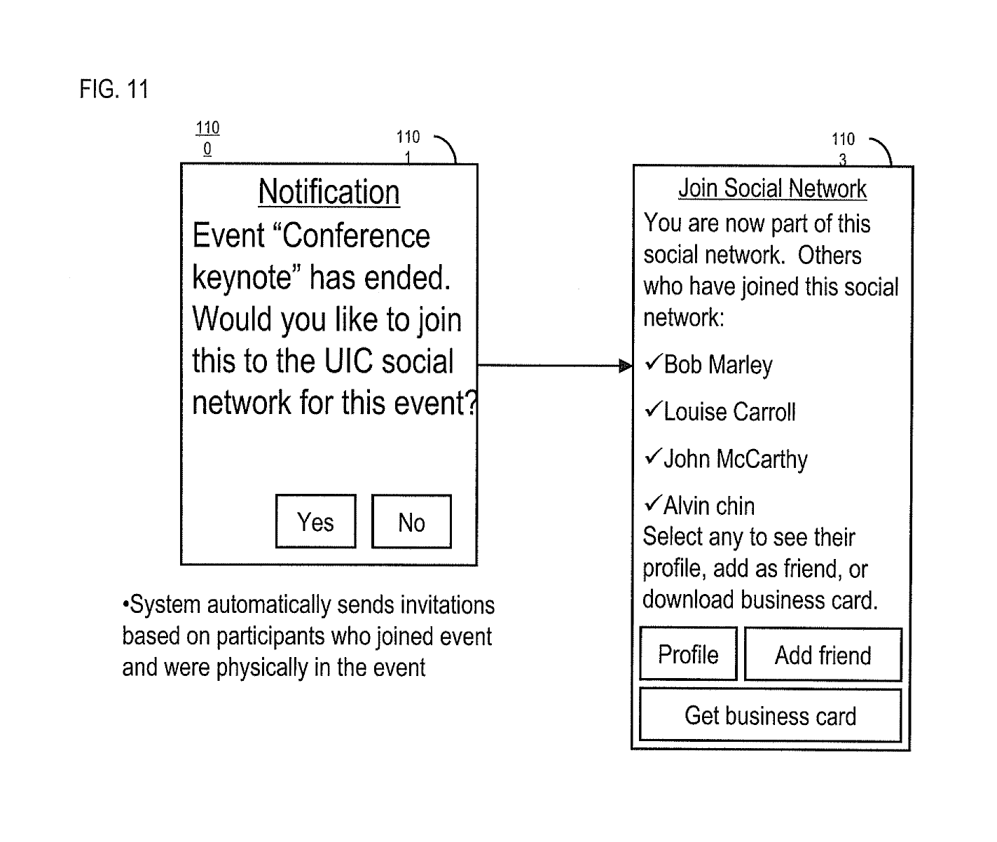

FIG. 11 illustrates an exemplary user interface 1100 that shows a series of user interface screens 1101-1103, according to one embodiment. The user interface 1100 may be generated in any of processes 200-400, as invitations for joining a social work based on at least one recommendation. At user interface screen 1101, the user is shown that the event the user attended has ended. An option is given to the user to join a social network that was created by the processing platform 103 based on the attendees at the event. If the user elects to join the social network for the event, the user is shown a user interface screen 1103. User interface 1103 illustrates the members of the social network that was created based on the event, and gives the user the option to view member profiles, ask for further contact information, or to invite additional individuals to join the network.

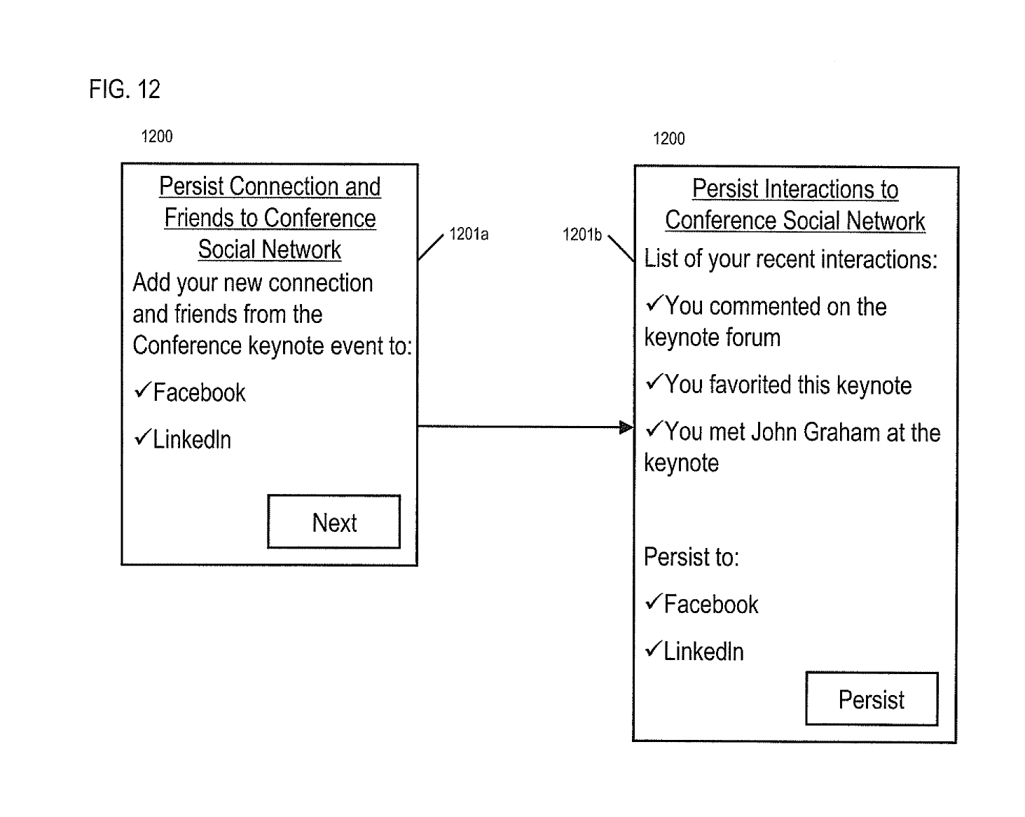

FIG. 12 is an illustration of a user interface 1200 that displays an option for a user to elect that a social network connection persist for longer than the event. In screen 1201a, the user may elect to have the social networking relationship persist, and also select various social networking services that the connection may persist in. The user interface for this option may be generated in response to step 315, discussed above and process 400 as well. The user may have an option to join an ephemeral social network for a short period of time and have their affiliation end at the conclusion of an event, However, the user may choose to remain connected to the connection made beyond the duration of the event, and have them persist. To persist means that the user would remain connected with any social networking relationships made in an ad-hoc social network (so long as the ad-hoc network exists), and/or any other existing social networking services that the user has elected the connection be affiliated with. Then, in screen 1201b, the user may specify information about the connection and their interactions with the connection or at the event.

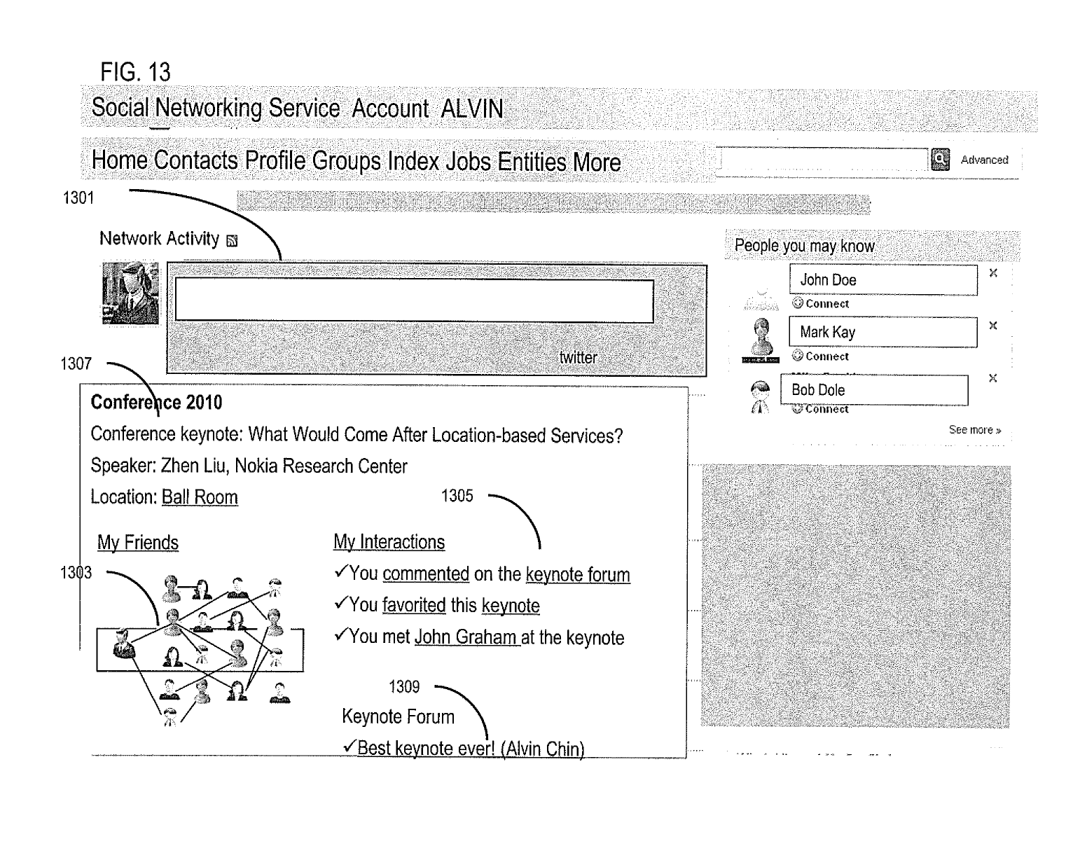

FIG. 13 is an exemplary user profile 1301 that is part of a social networking application, according to one embodiment. The user profile 1301 is used to depict a user's social network identity and share his connections 1303 and interactions 1305 with other users. The user may view his interactions 1303 with one or more users at one or more events 1307. The user may also opt to link comments, discuss, or leave feedback about an event 1309. The user profile 1301 may list a number of events 1307 so that the user may scroll through a series of events and parse his connections into various folders that are designated by an event. The user may then view his connections for each individual event, and/or select connections that the user would like to have appear along with other event information. For example, if a user has a connection that was made while attending a football game, but does not have the same connection when viewing league event information, the user may select the connection to link the selected connection to both the football game and the league event information, so that when the user is viewing the league event information, the connection may appear in the listing of friends while viewing the league event information. This would be advantageous because it would enable a user to quickly invite connections to related events should the user desire to invite other users to a particular event.

Another benefit to linking any ephemeral social networking connections to an existing social networking profile is to share those experiences with others so that others who may be interested may decide on their own accord that attending an event or joining a particular interest group may be beneficial to them. In this case, the network could continue to grow based on continually generating interest among users and further suggesting social networking relationships based upon similar interests, activities and context, as discussed above with respect to process 200, and particularly on step 209.

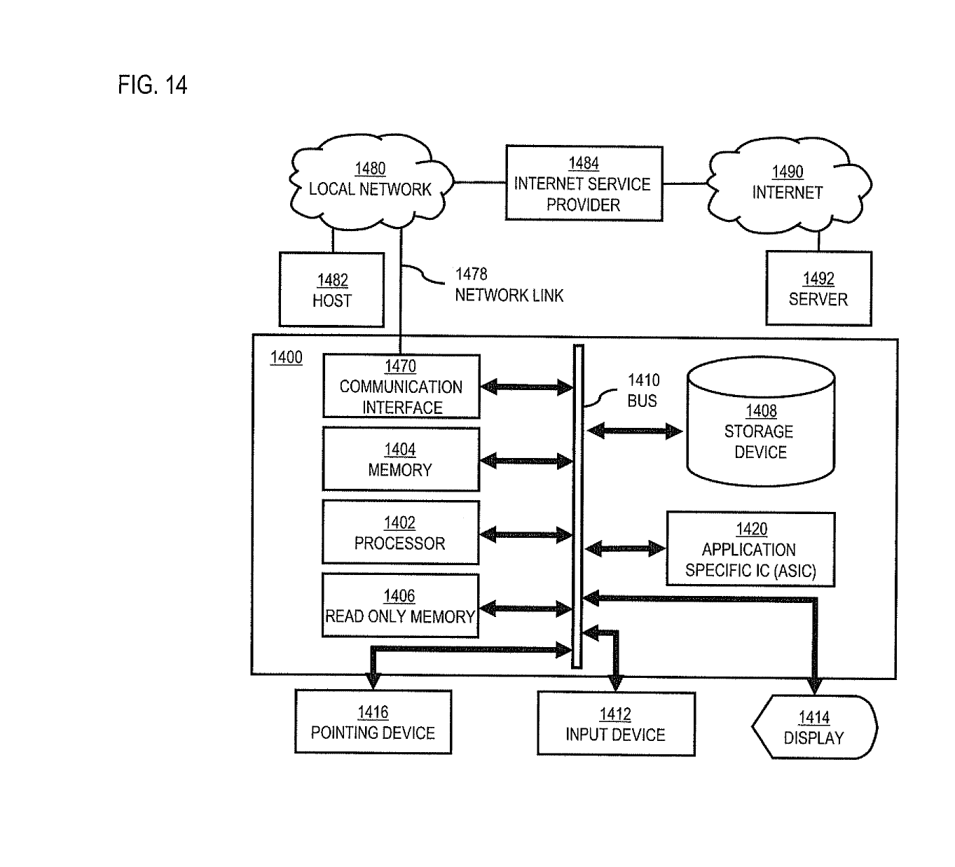

FIG. 14 illustrates a computer system 1400 upon which an embodiment of the invention may be implemented. Although computer system 1400 is depicted with respect to a particular device or equipment, it is contemplated that other devices or equipment (e.g., network elements, servers, etc.) within FIG. 14 can deploy the illustrated hardware and components of system 1400. Computer system 1400 is programmed (e.g., via computer program code or instructions) to present a suggested social networking connection as described herein and includes a communication mechanism such as a bus 1410 for passing information between other internal and external components of the computer system 1400. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1400, or a portion thereof, constitutes a means for performing one or more steps of presenting a suggested social networking connection.

A bus 1410 includes one or more parallel conductors of information so that information is transferred quickly among devices coupled to the bus 1410. One or more processors 1402 for processing information are coupled with the bus 1410.

A processor 1402 performs a set of operations on information as specified by computer program code related to present a suggested social networking connection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1410 and placing information on the bus 1410. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1402, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1400 also includes a memory 1404 coupled to bus 1410. The memory 1404, such as a random access memory (RAM) or other dynamic storage device, stores information including processor instructions for presenting a suggested social networking connection. Dynamic memory allows information stored therein to be changed by the computer system 1400. RAM allows a unit of information stored at a location called a memory address to be stored and retrieved independently of information at neighboring addresses. The memory 1404 is also used by the processor 1402 to store temporary values during execution of processor instructions. The computer system 1400 also includes a read only memory (ROM) 1406 or other static storage device coupled to the bus 1410 for storing static information, including instructions, that is not changed by the computer system 1400. Some memory is composed of volatile storage that loses the information stored thereon when power is lost. Also coupled to bus 1410 is a non-volatile (persistent) storage device 1408, such as a magnetic disk, optical disk or flash card, for storing information, including instructions, that persists even when the computer system 1400 is turned off or otherwise loses power.

Information, including instructions for presenting a suggested social networking connection, is provided to the bus 1410 for use by the processor from an external input device 1412, such as a keyboard containing alphanumeric keys operated by a human user, or a sensor. A sensor detects conditions in its vicinity and transforms those detections into physical expression compatible with the measurable phenomenon used to represent information in computer system 1400. Other external devices coupled to bus 1410, used primarily for interacting with humans, include a display device 1414, such as a cathode ray tube (CRT) or a liquid crystal display (LCD), or plasma screen or printer for presenting text or images, and a pointing device 1416, such as a mouse or a trackball or cursor direction keys, or motion sensor, for controlling a position of a small cursor image presented on the display 1414 and issuing commands associated with graphical elements presented on the display 1414. In some embodiments, for example, in embodiments in which the computer system 1400 performs all functions automatically without human input, one or more of external input device 1412, display device 1414 and pointing device 1416 is omitted.

In the illustrated embodiment, special purpose hardware, such as an application specific integrated circuit (ASIC) 1420, is coupled to bus 1410. The special purpose hardware is configured to perform operations not performed by processor 1402 quickly enough for special purposes. Examples of application specific ICs include graphics accelerator cards for generating images for display 1414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1400 also includes one or more instances of a communications interface 1470 coupled to bus 1410. Communication interface 1470 provides a one-way or two-way communication coupling to a variety of external devices that operate with their own processors, such as printers, scanners and external disks. In general the coupling is with a network link 1478 that is connected to a local network 1480 to which a variety of external devices with their own processors are connected. For example, communication interface 1470 may be a parallel port or a serial port or a universal serial bus (USB) port on a personal computer. In some embodiments, communications interface 1470 is an integrated services digital network (ISDN) card or a digital subscriber line (DSL) card or a telephone modem that provides an information communication connection to a corresponding type of telephone line. In some embodiments, a communication interface 1470 is a cable modem that converts signals on bus 1410 into signals for a communication connection over a coaxial cable or into optical signals for a communication connection over a fiber optic cable. As another example, communications interface 1470 may be a local area network (LAN) card to provide a data communication connection to a compatible LAN, such as Ethernet. Wireless links may also be implemented. For wireless links, the communications interface 1470 sends or receives or both sends and receives electrical, acoustic or electromagnetic signals, including infrared and optical signals, that carry information streams, such as digital data. For example, in wireless handheld devices, such as mobile telephones like cell phones, the communications interface 1470 includes a radio band electromagnetic transmitter and receiver called a radio transceiver. In certain embodiments, the communications interface 1470 enables connection to the communication network 105 for presenting a suggested social networking connection.

The term “computer-readable medium” as used herein to refers to any medium that participates in providing information to processor 1402, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1408. Volatile media include, for example, dynamic memory 1404. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1420.

Network link 1478 typically provides information communication using transmission media through one or more networks to other devices that use or process the information. For example, network link 1478 may provide a connection through local network 1480 to a host computer 1482 or to equipment 1484 operated by an Internet Service Provider (ISP). ISP equipment 1484 in turn provides data communication services through the public, world-wide packet-switching communication network of networks now commonly referred to as the Internet 1490.

A computer called a server host 1492 connected to the Internet hosts a process that provides a service in response to information received over the Internet. For example, server host 1492 hosts a process that provides information representing video data for presentation at display 1414. It is contemplated that the components of system 1400 can be deployed in various configurations within other computer systems, e.g., host 1482 and server 1492.

At least some embodiments of the invention are related to the use of computer system 1400 for implementing some or all of the techniques described herein. According to one embodiment of the invention, those techniques are performed by computer system 1400 in response to processor 1402 executing one or more sequences of one or more processor instructions contained in memory 1404. Such instructions, also called computer instructions, software and program code, may be read into memory 1404 from another computer-readable medium such as storage device 1408 or network link 1478. Execution of the sequences of instructions contained in memory 1404 causes processor 1402 to perform one or more of the method steps described herein. In alternative embodiments, hardware, such as ASIC 1420, may be used in place of or in combination with software to implement the invention. Thus, embodiments of the invention are not limited to any specific combination of hardware and software, unless otherwise explicitly stated herein.

The signals transmitted over network link 1478 and other networks through communications interface 1470, carry information to and from computer system 1400. Computer system 1400 can send and receive information, including program code, through the networks 1480, 1490 among others, through network link 1478 and communications interface 1470. In an example using the Internet 1490, a server host 1492 transmits program code for a particular application, requested by a message sent from computer 1400, through Internet 1490, ISP equipment 1484, local network 1480 and communications interface 1470. The received code may be executed by processor 1402 as it is received, or may be stored in memory 1404 or in storage device 1408 or other non-volatile storage for later execution, or both. In this manner, computer system 1400 may obtain application program code in the form of signals on a carrier wave.

Various forms of computer readable media may be involved in carrying one or more sequence of instructions or data or both to processor 1402 for execution. For example, instructions and data may initially be carried on a magnetic disk of a remote computer such as host 1482. The remote computer loads the instructions and data into its dynamic memory and sends the instructions and data over a telephone line using a modem. A modem local to the computer system 1400 receives the instructions and data on a telephone line and uses an infra-red transmitter to convert the instructions and data to a signal on an infra-red carrier wave serving as the network link 1478. An infrared detector serving as communications interface 1470 receives the instructions and data carried in the infrared signal and places information representing the instructions and data onto bus 1410. Bus 1410 carries the information to memory 1404 from which processor 1402 retrieves and executes the instructions using some of the data sent with the instructions. The instructions and data received in memory 1404 may optionally be stored on storage device 1408, either before or after execution by the processor 1402.

FIG. 15 illustrates a chip set 1500 upon which an embodiment of the invention may be implemented. Chip set 1500 is programmed to present a suggested social networking connection as described herein and includes, for instance, the processor and memory components described with respect to FIG. 14 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1500, or a portion thereof, constitutes a means for performing one or more steps of presenting a suggested social networking connection.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to present a suggested social networking connection. The memory 1505 also stores the data associated with or generated by the execution of the inventive steps.

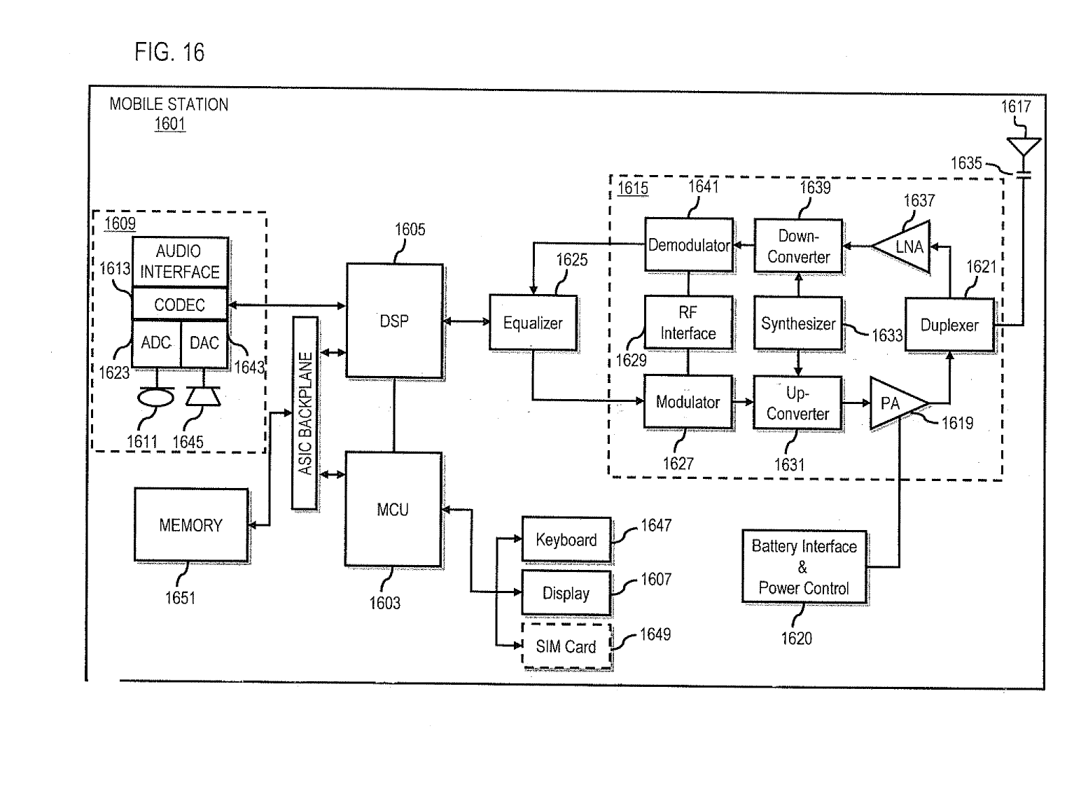

FIG. 16 is a diagram of exemplary components of a mobile terminal (e.g., handset) for communications, which is capable of operating in the system of FIG. 1, according to one embodiment. In some embodiments, mobile terminal 1600, or a portion thereof, constitutes a means for performing one or more steps of presenting a global view of information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile device or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile device or a similar integrated circuit in a cellular network device or other network devices.

Pertinent internal components of the telephone include a Main Control Unit (MCU) 1603, a Digital Signal Processor (DSP) 1605, and a receiver/transmitter unit including a microphone gain control unit and a speaker gain control unit. A main display unit 1607 provides a display to the user in support of various applications and mobile terminal functions that perform or support the steps of presenting a global view of information. The display 1607 includes display circuitry configured to display at least a portion of a user interface of the mobile terminal (e.g., mobile telephone). Additionally, the display 1607 and display circuitry are configured to facilitate user control of at least some functions of the mobile terminal. An audio function circuitry 1609 includes a microphone 1611 and microphone amplifier that amplifies the speech signal output from the microphone 1611. The amplified speech signal output from the microphone 1611 is fed to a coder/decoder (CODEC) 1613.

A radio section 1615 amplifies power and converts frequency in order to communicate with a base station, which is included in a mobile communication system, via antenna 1617. The power amplifier (PA) 1619 and the transmitter/modulation circuitry are operationally responsive to the MCU 1603, with an output from the PA 1619 coupled to the duplexer 1621 or circulator or antenna switch, as known in the art. The PA 1619 also couples to a battery interface and power control unit 1620.

In use, a user of mobile terminal 1601 speaks into the microphone 1611 and his or her voice along with any detected background noise is converted into an analog voltage. The analog voltage is then converted into a digital signal through the Analog to Digital Converter (ADC) 1623. The control unit 1603 routes the digital signal into the DSP 1605 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1625 for compensation of any frequency-dependent impairments that occur during transmission though the air such as phase and amplitude distortion. After equalizing the bit stream, the modulator 1627 combines the signal with a RF signal generated in the RF interface 1629, The modulator 1627 generates a sine wave by way of frequency or phase modulation. In order to prepare the signal for transmission, an up-converter 1631 combines the sine wave output from the modulator 3127 with another sine wave generated by a synthesizer 3133 to achieve the desired frequency of transmission. The signal is then sent through a PA 3119 to increase the signal to an appropriate power level. In practical systems, the PA 3119 acts as a variable gain amplifier whose gain is controlled by the DSP 1605 from information received from a network base station. The signal is then filtered within the duplexer 1621 and optionally sent to an antenna coupler 1635 to match impedances to provide maximum power transfer. Finally, the signal is transmitted via antenna 1617 to a local base station. An automatic gain control (AGC) can be supplied to control the gain of the final stages of the receiver. The signals may be forwarded from there to a remote telephone which may be another cellular telephone, other mobile device or a land-line connected to a Public Switched Telephone Network (PSTN), or other telephony networks.

Voice signals transmitted to the mobile terminal 1601 are received via antenna 1617 and immediately amplified by a low noise amplifier (LNA) 1637. A down-converter 1639 lowers the carrier frequency while the demodulator 1641 strips away the RF leaving only a digital bit stream. The signal then goes through the equalizer 1625 and is processed by the DSP 1605. A Digital to Analog Converter (DAC) 1643 converts the signal and the resulting output is transmitted to the user through the speaker 1645, all under control of a Main Control Unit (MCU) 1603 which can be implemented as a Central Processing Unit (CPU) (not shown).

The MCU 1603 receives various signals including input signals from the keyboard 1647. The keyboard 1647 and/or the MCU 1603 in combination with other user input components (e.g., the microphone 1611) comprise a user interface circuitry for managing user input. The MCU 1603 runs a user interface software to facilitate user control of at least some functions of the mobile terminal 1601 to present a global view of information. The MCU 1603 also delivers a display command and a switch command to the display 1607 and to the speech output switching controller, respectively. Further, the MCU 1603 exchanges information with the DSP 1605 and can access an optionally incorporated SIM card 1649 and a memory 1651. In addition, the MCU 1603 executes various control functions required of the terminal. The DSP 1605 may, depending upon the implementation, perform any of a variety of conventional digital processing functions on the voice signals. Additionally, DSP 1605 determines the background noise level of the local environment from the signals detected by microphone 1611 and sets the gain of microphone 1611 to a level selected to compensate for the natural tendency of the user of the mobile terminal 1601.

The CODEC 1613 includes the ADC 1623 and DAC 1643. The memory 1651 stores various data including call incoming tone data and is capable of storing other data including music data received via, e.g., the global Internet. The software module could reside in RAM memory, flash memory, registers, or any other form of writable storage medium known in the art. The memory device 1651 may be, but not limited to, a single memory, CD, DVD, ROM, RAM, EEPROM, optical storage, or any other non-volatile storage medium capable of storing digital data.

An optionally incorporated SIM card 1649 carries, for instance, important information, such as the cellular phone number, the carrier supplying service, subscription details, and security information. The SIM card 1649 serves primarily to identify the mobile terminal 1601 on a radio network. The card 1649 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-50. (canceled)

51. A method comprising facilitating a processing of and/or processing (1) data and/or (2) information and/or (3) at least one signal, the (1) data and/or (2) information and/or (3) at least one signal based, at least in part, on the following:
location information associated with a user and other location information associated with one or more other users;
a processing of the location information and the other location information to cause, at least in part, identification of one or more encounters, one or more encounter patterns, or a combination thereof with respect to the user and the one or more other users; and
at least one determination to generate at least one recommendation to create at least one social network, at least one social networking relationship, or a combination thereof between the user and at least one of the one or more other users based, at least in part, on the one or more encounters, the one or more encounter patterns, or a combination thereof.

52. A method of claim 51, wherein the (1) data and/or (2) information and/or (3) at least one signal are further based, at least in part, on the following:
a processing of the location information, the other location information, the one or more encounter patterns, or a combination thereof to cause, at least in part, designation of at least one event,
wherein the at least one recommendation is further based, at least in part, on the at least one event.

53. A method of claim 52, wherein the at least one social network, the at least one social networking relationship, or a combination thereof is formed for a duration of the at least one event.

54. A method of claim 52, wherein the (1) data and/or (2) information and/or (3) at least one signal are further based, at least in part, on the following:
an input for specifying one or more elements of the at least one social network, the at least one social networking relationship, or a combination thereof to persist after a completion of the at least one event.

55. A method of claim 52, wherein the (1) data and/or (2) information and/or (3) at least one signal are further based, at least in part, on the following:
event information from one or more network sources, one or more calendar applications or services, one or more activities, one or more event templates, or a combination thereof,
wherein the designation of the at least one event is further based, at least in part, on the event information.

56. A method of claim 51, wherein the (1) data and/or (2) information and/or (3) at least one signal are further based, at least in part, on the following:
one or more invitations for joining the social network, for creating the social networking relationship, or a combination thereof; and
at least one determination to transmit the one or more invitations to the user, the one or more other users, or a combination thereof.

57. A method of claim 51, wherein the (1) data and/or (2) information and/or (3) at least one signal are further based, at least in part, on the following:
context information associated with the user, other context information associated with the one or more other users, or a combination thereof,
wherein (a) the identification of the one or more encounters, the one or more encounter patterns, or a combination thereof; (b) the generation of the at least one recommendation; or (c) a combination thereof is further based, at least in part, on the context information.

58. A method of claim 51, wherein the (1) data and/or (2) information and/or (3) at least one signal are further based, at least in part, on the following:
a storage of the at least one social network, the at least one social networking relationship, or a combination thereof in one or more accounts associated with the user, the one or more other users, or a combination thereof.

59. A method of claim 51, wherein the (1) data and/or (2) information and/or (3) at least one signal are further based, at least in part, on the following:
a user interface to present, at least in part, the at least one recommendation, to the user, the one or more other users, the one or more encounters, the one or more encounter patterns, or combination thereof.

60. A method of claim 51, wherein the (1) data and/or (2) information and/or (3) at least one signal are further based, at least in part, on the following:
a presentation of the at least one recommendation based, at least in part, on the location information.

61. An apparatus comprising:
at least one processor; and
at least one memory including computer program code for one or more programs, the at least one memory and the computer program code configured to, with the at least one processor, cause the apparatus to perform at least the following,
determine location information associated with a user and other location information associated with one or more other users;
process and/or facilitate a processing of the location information and the other location information to cause, at least in part, identification of one or more encounters, one or more encounter patterns, or a combination thereof with respect to the user and the one or more other users; and
determine to generate at least one recommendation to create at least one social network, at least one social networking relationship, or a combination thereof between the user and at least one of the one or more other users based, at least in part, on the one or more encounters, the one or more encounter patterns, or a combination thereof.

62. An apparatus of claim 61, wherein the apparatus is further caused to:
process and/or facilitate a processing of the location information, the other location information, the one or more encounter patterns, or a combination thereof to cause, at least in part, designation of at least one event,
wherein the at least one recommendation is further based, at least in part, on the at least one event.

63. An apparatus of claim 62, wherein the at least one social network, the at least one social networking relationship, or a combination thereof is formed for a duration of the at least one event.

64. An apparatus of claim 62, wherein the apparatus is further caused to:
receive an input for specifying one or more elements of the at least one social network, the at least one social networking relationship, or a combination thereof to persist after a completion of the at least one event.

65. An apparatus of claim 62, wherein the apparatus is further caused to:
determine event information from one or more network sources, one or more calendar applications or services, one or more activities, one or more event templates, or a combination thereof,
wherein the designation of the at least one event is further based, at least in part, on the event information.

66. An apparatus of claim 61, wherein the apparatus is further caused to:
determine to generate one or more invitations for joining the social network, for creating the social networking relationship, or a combination thereof; and
determine to transmit the one or more invitations to the user, the one or more other users, or a combination thereof.

67. An apparatus of claim 61, wherein the apparatus is further caused to:
determine context information associated with the user, other context information associated with the one or more other users, or a combination thereof,
wherein (a) the identification of the one or more encounters, the one or more encounter patterns, or a combination thereof; (b) the generation of the at least one recommendation;
or (c) a combination thereof is further based, at least in part, on the context information.

68. An apparatus of claim 61, wherein the apparatus is further caused to cause, at least in part, storage of the at least one social network, the at least one social networking relationship, or a combination thereof in one or more accounts associated with the user, the one or more other users, or a combination thereof.

69. An apparatus of claim 61, wherein the apparatus is further caused to determine to generate a user interface to present, at least in part, the at least one recommendation, to the user, the one or more other users, the one or more encounters, the one or more encounter patterns, or combination thereof.

70. An apparatus of claim 61, wherein the apparatus is further caused to determine to initiate a presentation of the at least one recommendation based, at least in part, on the location information.

71. A method comprising:
determining location information associated with a user and other location information associated with one or more other users;
processing and/or facilitating a processing of the location information and the other location information to cause, at least in part, identification of one or more encounters, one or more encounter patterns, or a combination thereof with respect to the user and the one or more other users; and
determining to generate at least one recommendation to create at least one social network, at least one social networking relationship, or a combination thereof between the user and at least one of the one or more other users based, at least in part, on the one or more encounters, the one or more encounter patterns, or a combination thereof.
